(19) United States
(12) Patent Application Publication
(10) Pub. No.: US 2017/0201528 A1
(43) Pub. Date: Jul. 13, 2017

(54) METHOD FOR PROVIDING TRUSTED SERVICE BASED ON SECURE AREA AND APPARATUS USING THE SAME

(71) Applicant: ELECTRONICS AND TELECOMMUNICATIONS RESEARCH INSTITUTE, Daejeon (KR)

(72) Inventors: Geon-Lyang KIM, Daejeon (KR); Jeong-Nyeo KIM, Daejeon (KR)

(21) Appl. No.: 15/201,121

(22) Filed: Jul. 1, 2016

(30) Foreign Application Priority Data
Jan. 7, 2016 (KR) 10-2016-0002172

(51) Int. Cl. H04L 29/06; G06F 12/14

(52) U.S. Cl. CPC H04L 63/107; H04L 63/101; G06F 12/1408; G06F 2212/1052

(57) ABSTRACT

Disclosed herein are a method for providing trusted services based on a secure area and an apparatus using the method. The method for providing trusted services includes performing first authentication for using a trusted service of the secure area, created to be separate from a general area, based on a gateway application installed in a mobile terminal; creating a first session between the gateway application and the secure area based on a result of the first authentication and executing a security application based on the first session; performing second authentication for using the trusted service based on the security application; and creating a second session between the security application and the secure area based on a result of the second authentication and providing the trusted service based on the second session.

### CROSS REFERENCE TO RELATED APPLICATION

This application claims the benefit of Korean Patent Application No. 10-2016-0002172, filed Jan. 7, 2016, which is hereby incorporated by reference in its entirety into this application.

### BACKGROUND OF THE INVENTION

1. Technical Field

The present invention relates generally to technology for providing trusted services based on a secure area and, more particularly, to trusted service provision technology that may securely provide trusted services using security terminals that contain a secure area using virtualization.

2. Description of the Related Art

Recently, with the rapid proliferation of smart terminal devices, such smart terminal devices are increasingly used for storing both private data and enterprise data. However, in the case of smart terminal devices that run on an open operating system that lacks security, many issues pertaining to data security are being raised.

Particularly, due to methods for intentionally stealing data, such as illegally cloning terminals or hacking, or due to the loss of smart terminals attributable to a user's carelessness, confidential data stored in the smart terminals, for example, enterprise data, may be leaked to the outside. Therefore, organizations or companies that are sensitive to the leakage of confidential data, such as military data, enterprise data, government-related data, and the like, require a solution for providing trusted services in the smart terminals.

Therefore, required is new technology for trust and security services in which a secure area is constructed so as to be separate from a general area in the smart terminal based on virtualization technology such that the secure area enables confidential data to be securely stored and trusted services to be provided.

### Documents of Related Art

(Patent Document 1) Korean Patent Application Publication No. 10-2010-0008678, disclosed on Jan. 26, 2010 and titled “Method and system for providing application program using virtual machine, method for executing virtual application program, virtual machine module and method for providing on-line service”.

### SUMMARY OF THE INVENTION

An object of the present invention is to use a secure area that is separate from a general area that is vulnerable to hacking, and to thereby prevent sensitive data from illegally being leaked by unauthorized users.

Another object of the present invention is to conveniently and securely provide trusted services to users of smart terminals by blocking access from unauthorized users by periodically performing a user authentication process.

In order to accomplish the above object, a method for providing a trusted service based on a secure area according to the present invention includes performing first authentication for using a trusted service of a secure area, created so as to be separate from a general area, based on a gateway application installed in a mobile terminal; creating a first session between the gateway application and the secure area based on a result of the first authentication, and executing the security application based on the first session; performing second authentication for using the trusted service based on the security application; and creating a second session between the security application and the secure area based on a result of the second authentication, and providing the trusted service based on the second session.

Providing the trusted service may be configured to detect whether the trusted service is used, and to block the first session and the second session if use of the trusted service is not detected for a preset timeout interval.

Providing the trusted service may be configured to perform reauthentication of the gateway application and the user when the first session and the second session are blocked based on the preset timeout interval, and to provide the trusted service based on a result of the reauthentication.

Executing the security application may be configured to provide a security application list corresponding to the secure area based on the first session when the first authentication is completed, and to execute a security application selected by a user of the mobile terminal from among one or more security applications included in the security application list.

Performing the first authentication may be configured to perform at least one of authentication of the gateway application for using the trusted service and authentication of a user of the mobile terminal.

Performing the first authentication may be configured to perform the authentication of the user by providing an authentication screen for authenticating the user in the mobile terminal.

Performing the first authentication may be configured to perform the authentication of the gateway application based on an access control policy stored in the secure area.

Performing the second authentication may be configured to perform authentication of the security application based on an access control policy stored in the secure area.

The method may further include creating at least one of the first session and the second session as an encrypted session based on at least one encryption key stored in the secure area.

The method may further include blocking access to the secure area by removing the first session and the second session when the gateway application is terminated; and creating and managing an authentication policy, which is to be applied when performing at least one of the first authentication and the second authentication, by collecting events related to use of a trusted service in the secure area and by analyzing the events.

Also, an apparatus for providing a trusted service based on a secure area according to an embodiment of the present invention includes a first authentication unit for performing first authentication for using a trusted service of a secure area based on a gateway application; a security application execution unit for creating a first session between the gateway application and the secure area based on a result of the first authentication, and for executing a security application based on the first session; a second authentication unit for performing second authentication for using the trusted service based on the security application; and a trusted service provision unit for creating a second session between the security application and the secure area based on a result of the second authentication, and providing the trusted service based on the second session.

The trusted service provision unit may detect whether the trusted service is used, and may block the first session and the second session if use of the trusted service is not detected for a preset timeout interval.

The trusted service provision unit may perform reauthentication of the gateway application and the user when the first session and the second session are blocked based on the preset timeout interval, and may provide the trusted service based on a result of the reauthentication.

The security application execution unit may provide a security application list corresponding to the secure area based on the first session when the first authentication is completed, and may execute a security application selected by a user of a mobile terminal from among one or more security applications included in the security application list.

The first authentication unit may perform at least one of authentication of the gateway application for using the trusted service and authentication of a user of a mobile terminal.

The first authentication unit may perform the authentication of the user by providing an authentication screen for authenticating the user in the mobile terminal.

The first authentication unit may perform the authentication of the gateway application based on an access control policy stored in the secure area.

The second authentication unit may perform authentication of the security application based on an access control policy stored in the secure area.

The apparatus may further include a session creation unit for creating at least one of the first session and the second session as an encrypted session based on at least one encryption key stored in the secure area.

The apparatus may further include an access control unit for blocking access to the secure area by removing the first session and the second session when the gateway application is terminated, and for creating and managing an authentication policy, which is to be applied when performing at least one of the first authentication and the second authentication, by collecting events related to use of a trusted service in the secure area and by analyzing the events.

Also, as another means for accomplishing the object, the present invention provides a computer program stored in a medium in order to implement the above-described method.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an example of a smart security terminal according to the present invention;

FIG. 2 is a block diagram illustrating an apparatus for providing a trusted service according to an embodiment of the present invention;

FIGS. 3 to 5 are views illustrating an example of a user authentication process according to the present invention;

FIG. 6 is a flowchart illustrating a method for providing a trusted service according to an embodiment of the present invention;

FIG. 7 is a flowchart illustrating a method for providing a trusted service according to an embodiment of the present invention in detail;

FIG. 8 is a flowchart illustrating the process of reauthenticating a user based on a time period during which a trusted service is not used in the trusted service provision method illustrated in FIG. 6; and

FIG. 9 is a block diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

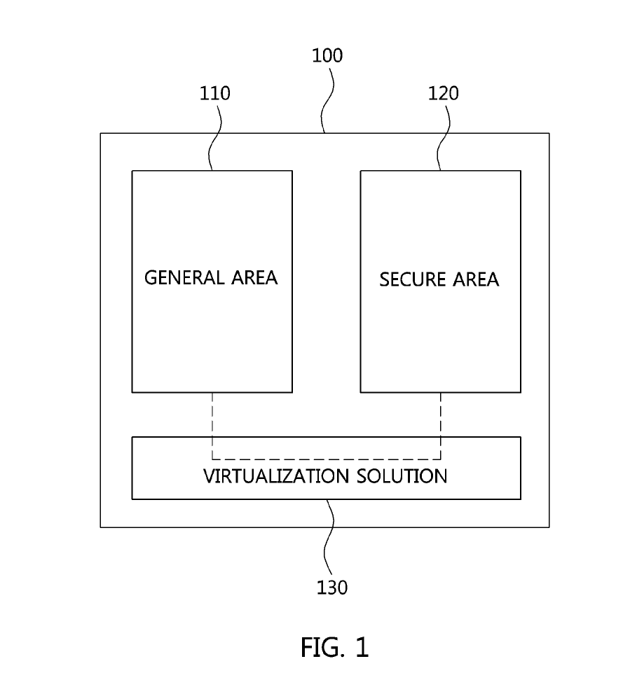

FIG. 1 is a block diagram illustrating an example of a smart security terminal according to the present invention.

Referring to FIG. 1, the smart security terminal 100 according to the present invention may provide a user with trusted services based on a secure area 120 by constructing the secure area 120, which is separate from a general area 110, based on a virtualization solution 130 using virtualization technology.

Specifically, the general area 110 of the smart security terminal 100 may be a user area in which user's private data are stored or processed. Also, the secure area 120 may correspond to an area for storing and processing data for which a high level of security is required, such as military data, enterprise data, or government-related data.

Here, the trusted service may be a service for storing sensitive data such as private keys, encryption and decryption keys, and the like in the secure area or a service for performing the encryption of data, creation of signatures, and the like.

Here, in order to enhance the security of various security applications that use the secure area 120, the access to the secure area 120 may be allowed only via a gateway application rather than direct access from the general area 110 to the secure area 120. Also, the access to the secure area 120 may be controlled by authenticating a user and the gateway application installed on the smart security terminal 100 at regular intervals.

Here, the sensitive data may be safely stored through the secure area 120, which is created using virtualization technology. Also, security functions, such as data encryption and decryption, may be performed based on the secure area 120.

Here, various applications are authenticated based on an access control policy of the secure area 120, and only trustworthy applications may be allowed to access the secure area 120. Primarily, trusted services may be prevented from being disclosed to unauthenticated users by using a hierarchical structure in which the use of the gateway application is required in order to access the security applications corresponding to the secure area 120.

Also, because the user of the smart security terminal 100 is authenticated and only an authenticated user is allowed to access sensitive data, an unauthorized user who picks up a lost or stolen terminal is prevented from accessing the sensitive data.

Also, when the user uses trusted services through a security application after the user has been successfully authenticated, user authentication is not required for each of the trusted services but the user is periodically authenticated. Therefore, the user may be provided with the trusted services more easily and securely.

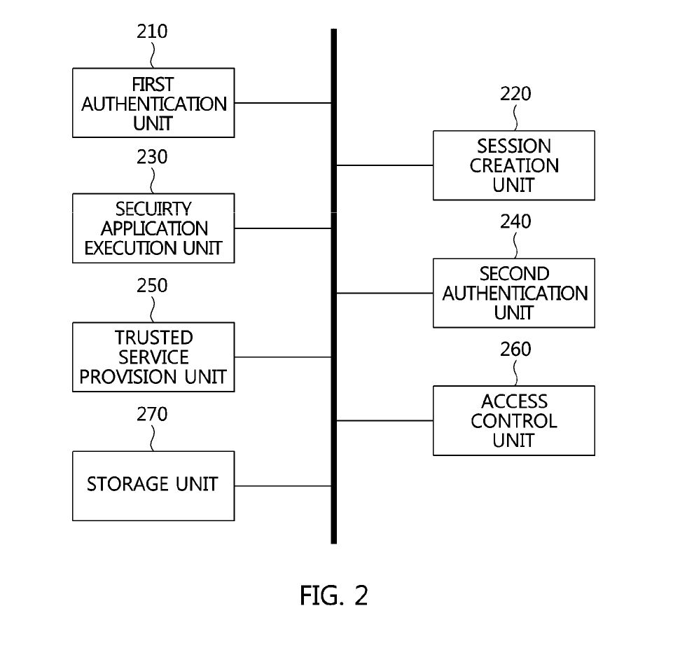

FIG. 2 is a block diagram illustrating an apparatus for providing a trusted service according to an embodiment of the present invention.

Referring to FIG. 2, the apparatus for providing a trusted service according to an embodiment of the present invention includes a first authentication unit 210, a session creation unit 220, a security application execution unit 230, a second authentication unit 240, a trusted service provision unit 250, an access control unit 260, and a storage unit 270.

The first authentication unit 210 performs first authentication in order to use a trusted service of a secure area based on a gateway application installed in a mobile terminal, the secure area being created so as to be separate from a general area.

Here, the gateway application may be an application for accessing a security application, which may use a trusted service stored in the secure area. In other words, because the general area and the secure area are configured to have a hierarchical structure, authentication is performed by executing the gateway application, and then access to the secure area may be allowed.

Here, at least one of authentication of the gateway application for using a trusted service and authentication of the user of the mobile terminal may be performed.

For example, a request to authenticate the gateway application is made, and if the authentication of the gateway application succeeds, a request to authenticate the user may be made to the secure area.

Here, in order to prevent the illegal leakage of sensitive data, authentication of a user is performed, whereby it may be checked whether the user who attempts to access the secure area is a user who has been authorized in advance. For example, if a user's mobile terminal is lost or stolen and then an unauthorized user picks it up, authentication of the user may prevent the unauthorized user from accessing the secure area.

Here, user authentication may be performed through various methods that may be implemented in mobile terminals, such as PIN authentication, fingerprint recognition, face recognition, and the like.

Here, user authentication may be performed by providing an authentication screen for authenticating a user in a mobile terminal. For example, a screen for receiving a PIN is provided, whereby a user may input a PIN through the mobile terminal.

Here, the gateway application may be authenticated based on the access control policy stored in the secure area. For example, the gateway application that attempts to access the secure area may be an application in which malicious code is included or an application that intentionally hacks into the secure area. In this case, access to the secure area may be prevented in advance by performing authentication based on information about the gateway application and the access control policy.

The session creation unit 220 creates a first session between the gateway application and the secure area based on the result of the first authentication.

For example, when both the gateway application and the user have been successfully authenticated, a request to create a session for the gateway application is made to the secure area, whereby the first session may be created.

Here, the first session may be created as a session encrypted based on at least one encryption key stored in the secure area.

Here, the session creation unit 220 may be configured separately, as shown in FIG. 2, or may be included in the security application execution unit 230, and may perform the operation for creating the first session.

The security application execution unit 230 executes a security application based on the first session.

In other words, as the first session is created, the security application for using a trusted service of the secure area may be accessed through the gateway application.

After the first authentication has been completed, a security application list of the secure area is provided based on the first session. Then, when the user of the mobile terminal selects a security application from among one or more security applications included in the security application list, the selected security application may be executed.

The second authentication unit 240 performs second authentication in order to use a trusted service based on the security application.

Here, the second authentication may correspond to a process in which the security application requests the security area to check the security application. That is, whether the security application is a trustworthy application may be checked based on the access control policy stored in the secure area and information about the security application.

Here, when a trusted service is used through the security application, the user authentication process may be skipped, whereby inconvenience that may be caused by authenticating the user whenever each of the security applications included in the security application list is used may be prevented.

The trusted service provision unit 250 provides a trusted service based on a second session, which is created between the security application and the secure area based on the result of the second authentication.

Here, the second session may be created by the session creation unit 220, which is separate from the trusted service provision unit 250, or by a session creation module.

Here, the session creation unit 220 or the session creation module may be included in the secure area.

Also, the session creation module may be included in the trusted service provision unit 250, which is included in the secure area.

Here, the second session may be created as a session encrypted based on an encryption key stored in the secure area.

Here, whether a trusted service is used is detected, and if the use of the trusted service has not been detected for a preset timeout interval, the first session and the second session may be blocked.

For example, when a user has not used a trusted service for a long time due to loss or neglect of a mobile terminal, the time period during which the trusted service has not been used may be checked. Here, if the checked time period is equal to or longer than the preset timeout interval, the first session and the second session may be blocked in order to prevent leakage of the sensitive data stored in the secure area.

Also, when the first session and the second session are blocked based on the preset timeout interval, the gateway application and the user are authenticated again, and the trusted service may be provided based on the result of the authentication. That is, user authentication is not performed for each of the security applications included in the security application list, but when the first session and the second session are blocked while using the trusted service, the first session is created again by reauthenticating the gateway application and the user, and the second session is created again by reauthenticating the security application, whereby the trusted service may be used in the same way as before the sessions were blocked.

Here, the time period during which the user does not use the trusted service may periodically be checked.

The access control unit 260 prevents access to the secure area by removing the first and second sessions when the gateway application is terminated.

For example, when the user terminates the gateway application because he or she does not use the trusted service any more, all the sessions corresponding to the secure area may be removed.

Here, when the gateway application is terminated, a request to remove all the sessions may be made to the secure area.

Also, the access control unit 260 may create and manage an authentication policy, which is to be applied when at least one of the first authentication and the second authentication is performed, by collecting and analyzing events related to the use of the trusted services of the secure area.

Here, the event related to the use of the trusted services may contain information about the kind of trusted service that is provided or the data to be used in the secure area.

For example, applications that are allowed to access the secure area are included in a whitelist, and applications that are blocked from accessing the secure area are included in a blacklist. Then, the whitelist and the blacklist may be used when authenticating the gateway application and when authenticating the security application. Also, the whitelist and the blacklist may be updated by analyzing the periodically collected events.

As another example, in the case in which the first and second sessions are blocked owing to the preset timeout interval, the preset timeout interval may be changed depending on the result of analysis of the events. That is, when the security is suspect based on the result of analysis of the events, security may be improved by reducing the timeout interval, rather than setting an identical timeout interval for all cases.

The storage unit 270 stores various kinds of information generated in the process of providing trusted services according to an embodiment of the present invention, as described above.

According to an embodiment, the storage unit 270 may be separate from the trusted service provision apparatus, and may support a function for providing trusted services. Here, the storage unit 270 may operate as separate mass storage and may include a control function for the operation.

Through the above-mentioned trusted service provision apparatus, a user using a smart terminal may be easily and conveniently provided with trusted services.

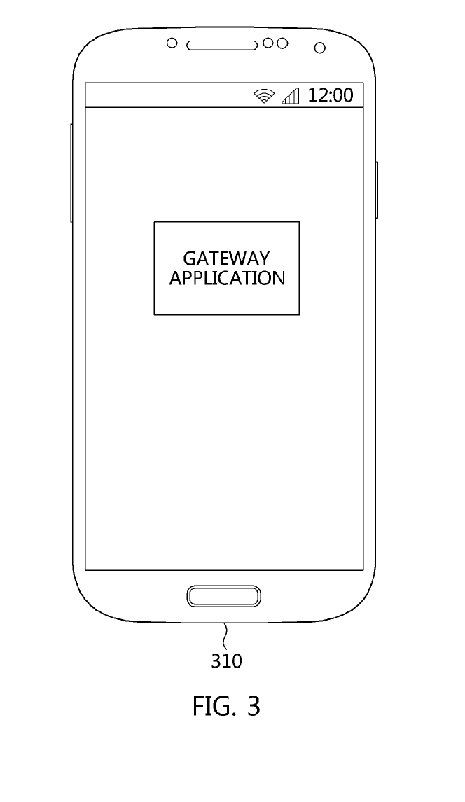

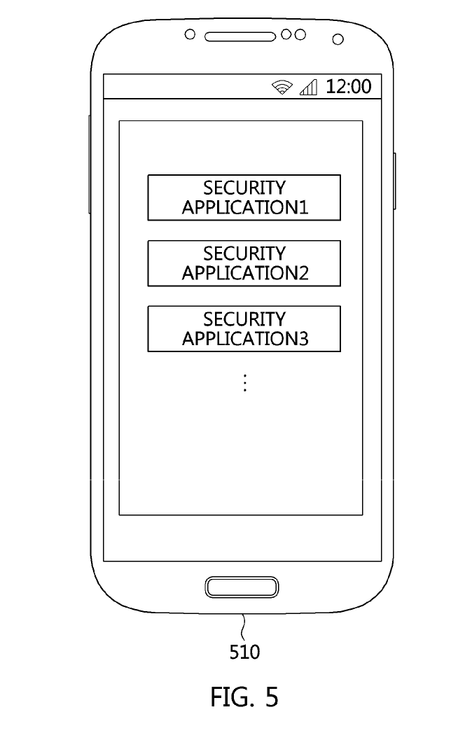

FIGS. 3 to 5 are views illustrating an example of a user authentication process according to the present invention.

Referring to FIGS. 3 to 5, first, a gateway application may be executed on the screen 310 of a mobile terminal in order to use a trusted service in the mobile terminal.

Here, when the gateway application is executed, user authentication, which corresponds to the first authentication for using the trusted service, may be performed.

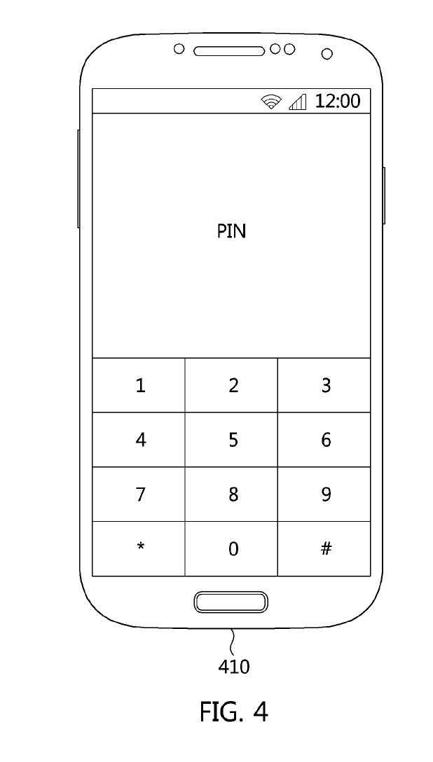

For example, user authentication may be the process of inputting a PIN through the authentication information input screen 410 illustrated in FIG. 4.

Here, user authentication may be performed through various methods that may be implemented using a mobile terminal, in addition to the method using a PIN, which is illustrated in FIG. 4. For example, user authentication may be performed using fingerprint recognition or face recognition through a fingerprint recognition screen or a face recognition screen displayed on the mobile terminal.

When user authentication succeeds, a list screen 510 that shows security applications that may use a trusted service may be displayed on the mobile terminal.

Here, a user may select a specific security application from among the security applications displayed on the list screen 510 and execute it, whereby the user may be provided with a trusted service of the secure area.

Here, it is assumed that a user neglects a terminal during interruption of use of the trusted service and that the time period during which the user has not used the trusted service exceeds a preset timeout interval. In this case, this may be detected in the secure area, whereby the session corresponding to the security application may be blocked in order to prevent the trusted service from being used.

Here, in order to use the trusted service again, user authentication, illustrated in FIG. 4, may be performed again. When the user authentication succeeds, the user may use the trusted service in the same way as before by again connecting the session corresponding to the security application.

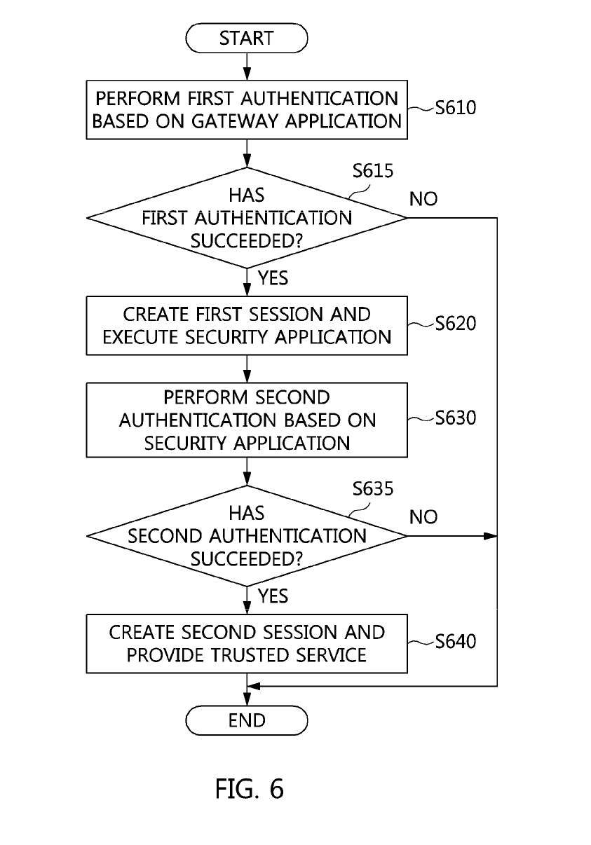

FIG. 6 is a flowchart illustrating a method for providing a trusted service according to an embodiment of the present invention.

Referring to FIG. 6, in the method for providing a trusted service according to an embodiment of the present invention, first authentication is performed at step S610 in order to use a trusted service of a secure area, which is created so as to be separate from a general area, based on a gateway application installed in a mobile terminal.

Here, the gateway application may be an application for accessing a security application that may use a trusted service stored in the secure area. In other words, because the general area and the secure area are configured to have a hierarchical structure, authentication is performed by executing the gateway application, and then access to the secure area may be allowed.

Here, at least one of authentication of the gateway application for using a trusted service and authentication of the user of the mobile terminal may be performed.

For example, a request to authenticate the gateway application is made, and if the authentication of the gateway application succeeds, a request to authenticate the user may be made to the secure area.

Here, in order to prevent the illegal leakage of sensitive data, authentication of a user is performed, whereby it may be checked whether the user who attempts to access the secure area is a user who has been authorized in advance. For example, if a user's mobile terminal is lost or stolen, and then an unauthorized user picks it up, authentication of the user may prevent the unauthorized user from accessing the secure area.

Here, user authentication may be performed through various methods that may be implemented in mobile terminals, such as PIN authentication, fingerprint recognition, face recognition, and the like.

Here, user authentication may be performed by providing an authentication screen for authenticating a user in a mobile terminal. For example, a screen for receiving a PIN is provided, whereby a user may input a PIN through the mobile terminal.

Here, the gateway application may be authenticated based on the access control policy stored in the secure area. For example, the gateway application that attempts to access the secure area may be an application that contains malicious code or an application that intentionally hacks into the secure area. In this case, the access to the secure area may be prevented in advance by performing authentication based on information about the gateway application and the access control policy.

Also, in the method for providing a trusted service according to an embodiment of the present invention, whether or not the first authentication succeeds is checked at step S615.

If it is determined at step S615 that the first authentication has not succeeded, the gateway application may be prevented from accessing the secure area.

Conversely, if it is determined at step S615 that the first authentication has succeeded, a first session between the gateway application and the secure area is created, and the security application is executed based on the first session at step S620 in the method for providing a trusted service according to an embodiment of the present invention.

For example, when both the gateway application and the user have been successfully authenticated, a request to create a session for the gateway application is made to the secure area, whereby the first session may be created.

Here, the first session may be created as a session encrypted based on at least one encryption key stored in the secure area.

Also, as the first session is created, the security application for using a trusted service of the secure area may be accessed through the gateway application.

After the first authentication has been completed, a security application list of the secure area is provided based on the first session. Then, when the user of the mobile terminal selects a security application from among one or more security applications included in the security application list, the selected security application may be executed.

Also, in the method for providing a trusted service according to an embodiment of the present invention, the second authentication is performed at step S630 in order to use the trusted service based on the security application.

Here, the second authentication may correspond to a process in which the security application requests the secure area to check the security application. That is, whether the security application is a trustworthy application may be checked based on the access control policy stored in the secure area and information about the security application.

Here, when a trusted service is used through the security application, a user authentication process may be skipped, whereby inconvenience that may be caused by authenticating the user every time each of the security applications included in the security application list is used may be prevented.

Also, in the method for providing a trusted service according to an embodiment of the present invention, whether or not the second authentication succeeds is checked at step S635.

If it is determined at step S635 that the second authentication has not succeeded, the security application may be prevented from accessing the secure area.

Conversely, if it is determined at step S635 that the second authentication has succeeded, a second session between the security application and the secure area is created, and a trusted service is provided based on the second session at step S640 in the method for providing a trusted service according to an embodiment of the present invention.

Here, the second session may be created as a session encrypted based on an encryption key stored in the secure area.

Here, whether a trusted service is used is detected, and if use of the trusted service has not been detected for a preset timeout interval, the first session and the second session may be blocked.

For example, when a user has not used a trusted service for a long time due to the loss or neglect of a mobile terminal, the time period during which the trusted service has not been used may be checked. Here, if the checked time period is equal to or longer than the preset timeout interval, the first session and the second session may be blocked in order to prevent leakage of the sensitive data stored in the secure area.

Also, when the first session and the second session are blocked based on the preset timeout interval, the gateway application and the user are authenticated again, and the trusted service may be provided based on the result of the authentication. That is, user authentication is not performed for each of the security applications included in the security application list, but when the first session and the second session are blocked while using the trusted service, the first session is created again by reauthenticating the gateway application and the user, and the second session is created again by reauthenticating the security application, whereby the trusted service may be used in the same way as before the sessions were blocked.

Here, the time period during which the user does not use the trusted service may periodically be checked.

Also, although not illustrated in FIG. 6, in the method for providing a trusted service according to an embodiment of the present invention, when the gateway application is terminated, the first and second sessions are removed in order to prevent the access to the secure area.

For example, when the user terminates the gateway application because he or she does not use the trusted service any more, all the sessions corresponding to the secure area may be removed.

Here, when the gateway application is terminated, a request to remove all of the sessions may be made to the secure area.

Also, although not illustrated in FIG. 6, in the method for providing a trusted service according to an embodiment of the present invention, an authentication policy, which is to be applied when performing at least one of the first authentication and the second authentication, may be created and managed by collecting and analyzing events related to the use of the trusted services in the secure area.

Here, the event related to the use of the trusted services may contain information about the kind of trusted service that is provided or the data that are used in the secure area.

For example, applications that are allowed to access the secure area are included in a whitelist, and applications that are blocked from accessing the secure area are included in a blacklist. Then, the whitelist and the blacklist may be used when authenticating the gateway application and when authenticating the security application. Also, the whitelist and the blacklist may be updated by analyzing the periodically collected events.

In another example, in the case in which the first and second sessions are blocked by the preset timeout interval, the preset timeout interval may be changed depending on the result of analysis of the events. That is, when the security is suspect based on the result of analysis of the events, security may be improved by reducing the timeout interval, rather than setting an identical timeout interval for all cases.

Also, although not illustrated in FIG. 6, in the method for providing a trusted service according to an embodiment of the present invention, various kinds of information, generated in the process of providing trusted services according to an embedment of the present invention as described above, are stored in a storage module.

According to an embodiment, the storage module may be separate from the apparatus for providing a trusted service, and may support a function for providing trusted services. Here, the storage module may operate as separate mass storage and include a control function for the operation.

Through the above-mentioned method for providing a trusted service, a user using a smart terminal may be securely and conveniently provided with trusted services.

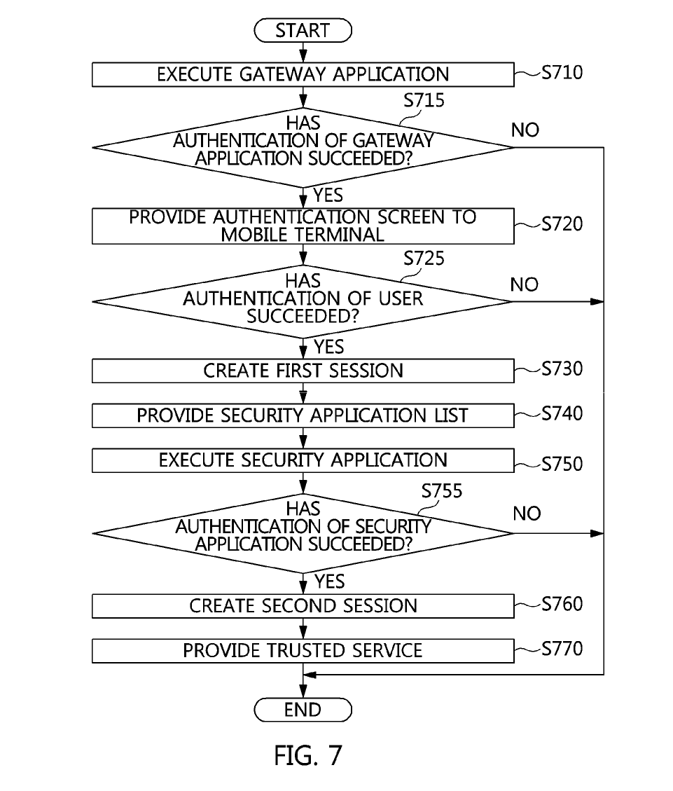

FIG. 7 is a flowchart illustrating the method for providing a trusted service according to an embodiment of the present invention in more detail.

Referring to FIG. 7, in the method for providing a trusted service according to the present invention, a gateway application is executed at step S710.

Here, the gateway application may be an application for accessing a security application that may use a trusted service stored in the secure area. In other words, because the general area and the secure area are configured in a hierarchical structure, authentication is performed by executing the gateway application, and then access to the secure area may be allowed.

Then, whether authentication of the gateway application has succeeded is determined at step S715.

Here, a request to authenticate the gateway application is made to the secure area using the gateway application.

If it is determined at step S715 that authentication of the gateway application has not succeeded, the gateway application may be prevented from accessing the secure area.

In other words, if authentication fails, the gateway application is determined to be an unreliable application, and thus access to the secure area may be prevented.

Conversely, if it is determined at step S715 that the gateway application has been successfully authenticated, an authentication screen is provided to the mobile terminal at step S720 in order to authenticate the user.

Here, user authentication may be performed in order to prevent the illegal leakage of sensitive data stored in the secure area.

Subsequently, it is determined at step S725 whether the user authentication, performed based on authentication information that is input to correspond to the authentication screen, succeeds.

Here, user authentication may be performed through various methods such as PIN authentication, fingerprint recognition, face recognition, and the like.

If it is determined at step S725 that user authentication has not succeeded, the gateway application may be prevented from accessing the secure area.

In other words, if the user authentication fails, the corresponding user is determined to be an unauthorized user, and may be blocked from accessing the secure area.

Conversely, if it is determined at step S725 that the user authentication has succeeded, a first session between the gateway application and the secure area is created at step S730.

Here, the first session may be created based on at least one encryption key stored in the secure area.

Then, a security application list is provided at step S740.

Here, the security application list may include at least one security application corresponding to an available trusted service based on the secure area.

Then, a security application, selected in the security application list by the user, is executed at step S750.

Then, at step S755, whether authentication of the security application in the secure area has succeeded is determined based on the security application.

Here, whether the security application is a trustworthy application is determined using an access control policy stored in the secure area and information about the security application.

If it is determined at step S755 that the authentication of the security application has not succeeded, the security application may be prevented from accessing the secure area.

Conversely, if it is determined at step S755 that the authentication of the security application has succeeded, a second session between the security application and the secure area is created at step S760.

Here, the second session may be a session encrypted based on at least one encryption key stored in the secure area.

Then, the trusted service is provided based on the second session at step S770.

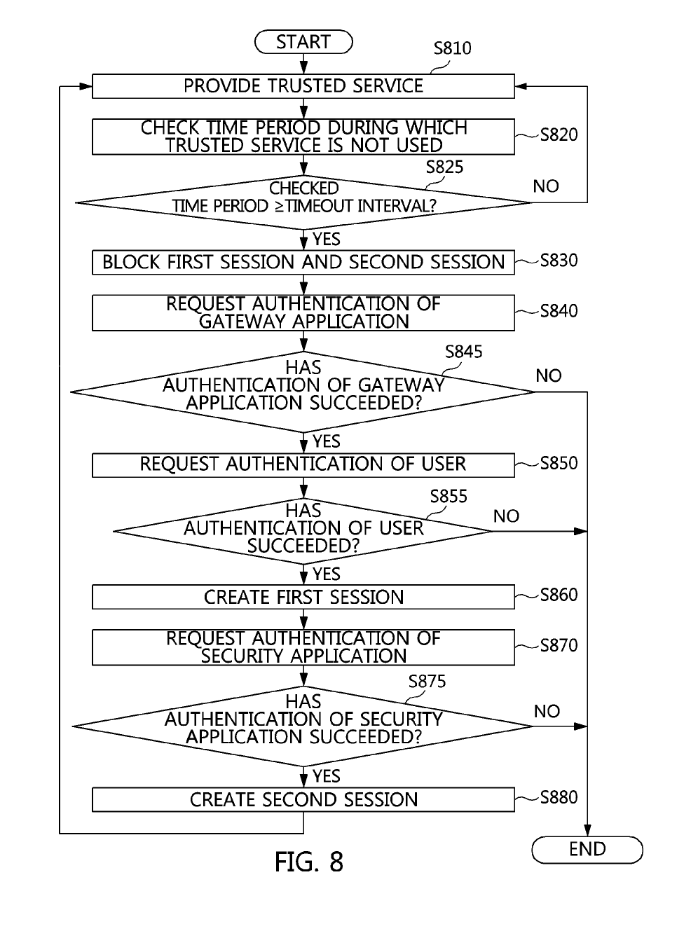

FIG. 8 is a flowchart illustrating the process of reauthenticating a user based on the time period during which a trusted service has not been used in the method for providing a trusted service, illustrated in FIG. 6.

Referring to FIG. 8, in the process of reauthenticating a user based on the time period during which the trusted service has not been used in the method for providing a trusted service, illustrated in FIG. 6, first, the time period during which a user has not used the trusted service after the trusted service was provided at step S810 is checked at step S820.

Then, whether the checked time period is equal to or longer than a preset timeout interval is determined at step S825.

If it is determined at step S825 that the checked time period is shorter than the preset timeout interval, the trusted services is continuously provided at step S810.

Conversely, if it is determined at step S825 that the checked time period is equal to or longer than the preset timeout interval, both the first session, corresponding to the gateway application, and the second session, corresponding to the security application, are blocked at step S830.

Then, a request to authenticate the gateway application is made at step S840, and whether authentication of the gateway application has succeeded is determined at step S845.

If it is determined at step S845 that authentication of the gateway application has failed, access to the security may be blocked.

Conversely, if it is determined at step S845 that authentication of the gateway application has succeeded, a request to authenticate the user is made at step S850.

Here, user authentication may be performed through various methods that may be implemented in terminals, such as PIN authentication, fingerprint recognition, face recognition, and the like.

Then, whether the authentication of the user has succeeded is determined at step S855.

If it is determined at step S855 that authentication of the user has failed, the first session is not created, whereby the access to the secure area may be prevented.

Conversely, if it is determined at step S855 that authentication of the user has succeeded, the first session is created at step S860. Also, a request to authenticate the security application is made at step S870 by accessing the secure area based on the first session.

Then, whether the authentication of the security application has succeeded is determined at step S875.

If it is determined at step S875 that the authentication of the security application has succeeded, the second session is created at step S880, and the trusted service is provided to the user at step S810.

Conversely, if it is determined at step S875 that the authentication of the security application has failed, the second session is not created, and thus the trusted service may not be provided.

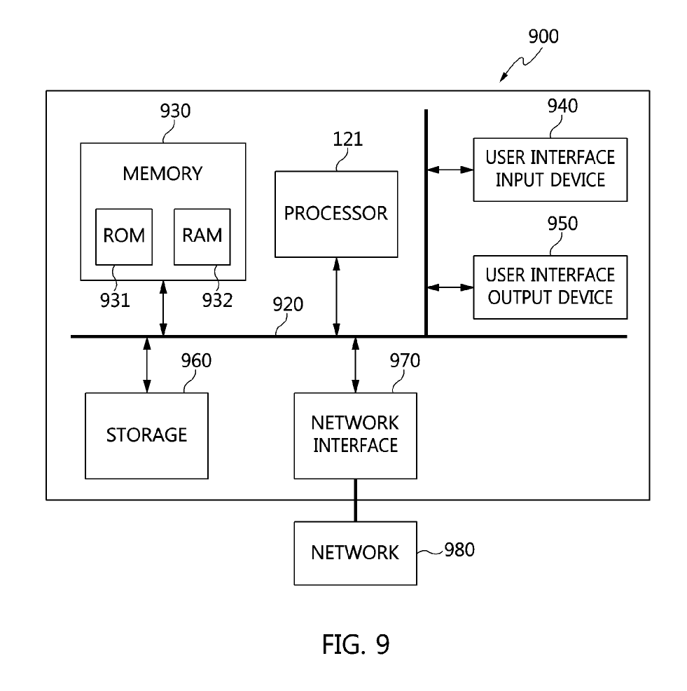

FIG. 9 is a block diagram illustrating a computer system according to an embodiment of the present invention.

Referring to FIG. 9, an embodiment of the present invention may be implemented in a computer system including a computer-readable storage medium. As illustrated in FIG. 9, the computer system 900 may include one or more processors 910, memory 930, a user input device 940, a user output device 950, and storage 960, which communicate with each other via a bus 920. Also, the computer system 900 may further include a network interface 970 connected to a network 980. The processor 910 may be a central processing unit (CPU) or a semiconductor device for executing processing instructions stored in the memory 930 or the storage 960. The memory 930 and the storage 960 may be various types of volatile or nonvolatile storage medium. For example, the memory may include ROM 931 or RAM 932.

Accordingly, an embodiment of the present invention may be implemented as a method using a computer or as a computer-readable medium in which instructions executed by a computer are recorded. When the computer-readable instructions are executed by a processor, the computer-readable instructions may perform a method according to at least one aspect of the present invention.

According to the present invention, the illegal leakage of sensitive data by unauthorized users may be prevented using a secure area that is separate from a general area, which is prone to be hacked into.

Also, the present invention may conveniently and securely provide trusted services to users of smart terminals by blocking unauthorized users from access by periodically performing a user authentication process.

As described above, a method and apparatus for providing a trusted service based on a secure area according to the present invention are not limitedly applied to the configurations and operations of the above-described embodiments, but all or some of the embodiments may be selectively combined and configured so that the embodiments may be modified in various ways.

What is claimed is:

1. A method for providing a trusted service based on a secure area, comprising:
performing first authentication for using a trusted service of a secure area, created so as to be separate from a general area, based on a gateway application installed in a mobile terminal;
creating a first session between the gateway application and the secure area based on a result of the first authentication, and executing the security application based on the first session;
performing second authentication for using the trusted service based on the security application; and
creating a second session between the security application and the secure area based on a result of the second authentication, and providing the trusted service based on the second session.

2. The method of claim 1, wherein providing the trusted service is configured to:
detect whether the trusted service is used; and
block the first session and the second session if use of the trusted service is not detected for a preset timeout interval.

3. The method of claim 2, wherein providing the trusted service is configured to:
perform reauthentication of the gateway application and the user when the first session and the second session are blocked based on the preset timeout interval; and
provide the trusted service based on a result of the reauthentication.

4. The method of claim 1, wherein executing the security application is configured to:
provide a security application list corresponding to the secure area based on the first session when the first authentication is completed; and
execute a security application selected by a user of the mobile terminal from among one or more security applications included in the security application list.

5. The method of claim 1, wherein performing the first authentication is configured to perform at least one of authentication of the gateway application for using the trusted service and authentication of a user of the mobile terminal.

6. The method of claim 5, wherein performing the first authentication is configured to perform the authentication of the user by providing an authentication screen for authenticating the user in the mobile terminal

7. The method of claim 5, wherein performing the first authentication is configured to perform the authentication of the gateway application based on an access control policy stored in the secure area.

8. The method of claim 1, wherein performing the second authentication is configured to perform authentication of the security application based on an access control policy stored in the secure area.

9. The method of claim 1, further comprising,
creating at least one of the first session and the second session as an encrypted session based on at least one encryption key stored in the secure area.

10. The method of claim 1, further comprising:
blocking access to the secure area by removing the first session and the second session when the gateway application is terminated; and
creating and managing an authentication policy, which is to be applied when performing at least one of the first authentication and the second authentication, by collecting events related to use of a trusted service in the secure area and by analyzing the events.

11. An apparatus for providing a trusted service based on a secure area, comprising:
a first authentication unit for performing first authentication for using a trusted service of a secure area based on a gateway application;
a security application execution unit for creating a first session between the gateway application and the secure area based on a result of the first authentication, and for executing a security application based on the first session;
a second authentication unit for performing second authentication for using the trusted service based on the security application; and
a trusted service provision unit for creating a second session between the security application and the secure area based on a result of the second authentication, and providing the trusted service based on the second session.

12. The apparatus of claim 11, wherein the trusted service provision unit is configured to:
detect whether the trusted service is used, and
block the first session and the second session if use of the trusted service is not detected for a preset timeout interval.

13. The apparatus of claim 12, wherein the trusted service provision unit is configured to:
perform reauthentication of the gateway application and the user when the first session and the second session are blocked based on the preset timeout interval, and
provide the trusted service based on a result of the reauthentication.

14. The apparatus of claim 11, wherein the security application execution unit is configured to:
provide a security application list corresponding to the secure area based on the first session when the first authentication is completed, and
execute a security application selected by a user of a mobile terminal from among one or more security applications included in the security application list.

15. The apparatus of claim 11, wherein the first authentication unit performs at least one of authentication of the gateway application for using the trusted service and authentication of a user of a mobile terminal.

16. The apparatus of claim 15, wherein the first authentication unit performs the authentication of the user by providing an authentication screen for authenticating the user in the mobile terminal.

17. The apparatus of claim 15, wherein the first authentication unit performs the authentication of the gateway application based on an access control policy stored in the secure area.

18. The apparatus of claim 11, wherein the second authentication unit performs authentication of the security application based on an access control policy stored in the secure area.

19. The apparatus of claim 11, further comprising,
a session creation unit for creating at least one of the first session and the second session as an encrypted session based on at least one encryption key stored in the secure area.

20. The apparatus of claim 11, further comprising:
an access control unit for blocking access to the secure area by removing the first session and the second session when the gateway application is terminated, and for creating and managing an authentication policy, which is to be applied when performing at least one of the first authentication and the second authentication, by collecting events related to use of a trusted service in the secure area and by analyzing the events.
